(19) United States
(12) Patent Application Publication
(10) Pub. No.: US 2008/0140393 A1
(43) Pub. Date: Jun. 12, 2008

(54) SPEECH CODING APPARATUS AND METHOD

(75) Inventors: Hyun-Woo KIM, Daejeon-city (KR); Do Young Kim, Daejeon-city (KR); Hae Won Jung, Daejeon-city (KR)

Correspondence Address: RABIN & Berdo, PC, 1101 14TH STREET, NW, SUITE 500, WASHINGTON, DC, 20005, US

(73) Assignee: ELECTRONICS & TELECOMMUNICATIONS RESEARCH INSTITUTE, Daejeon (KR)

(21) Appl. No.: 11/929,922

(22) Filed: Oct. 30, 2007

(30) Foreign Application Priority Data
Dec. 8, 2006 (KR) 10-2006-0125139

(51) Int. Cl. G10L 11/04

(52) U.S. Cl. 704/206; 704/E19.014

(57) ABSTRACT

Provided is a speech coding apparatus and method. A band divider divides an input signal into a high-band signal and a low-band signal, a narrowband encoder encodes the low-band signal using a Code Excited Linear Prediction (CELP)-based narrowband speech codec, a frequency characteristic collector converts the high-band signal to a signal in a frequency domain and obtains Modified Discrete Cosine Transform (MDCT) coefficients, a subband determiner determines subbands in a final stage based on the MDCT coefficients and determines subbands for quantization based on the subbands in a final stage, a gain quantizer performs gain quantization of the subbands, a bit assignment unit assigns bits to the subbands according to the magnitude of the gain quantization, and a shape quantizer performs shape quantization of the subbands in an algebraic method. Accordingly, algorithm consistency can be maintained and a complexity can be reduced by extending a bandwidth with a small number of bits in a speech codec.

### CROSS-REFERENCE TO RELATED PATENT APPLICATION

This application claims the benefit of Korean Patent Application No. 10-2006-0125139, filed on Dec. 8, 2006, in the Korean Intellectual Property Office, the disclosure of which is incorporated herein in its entirety by reference.

### BACKGROUND OF THE INVENTION

1. Field of the Invention

The present invention relates to speech coding/decoding, and more particularly, to a speech coding method of extending a bandwidth with a smaller number of bits in a speech codec.

This work was supported by the IT R&D program of MIC/IITA [2005-S-100-02, Development of Multi-codec and its control technology providing variable bandwidth scalability].

2. Description of the Related Art

Technology of processing a digital signal, which is easy in transmission and operation compared to an analog signal, has been developing. A Pulse Code Modulation (PCM) signal is obtained by sampling and quantizing an analog signal, and since an amount of the PCM signal is too large to directly process, there is a big problem in storing, transmission, and reproduction of the PCM signal. Thus, many codecs for compressing and decompressing a PCM signal have been developed.

Speech codecs achieve a high compression rate based on Code Excited Linear Prediction (CELP) technology in which a speech generation process is modeled. Representative codecs are G.729A, G.723.1 Adaptive Multi-Rate (AMR), and the like. Audio codecs decode/encode a PCM signal using a psychoacoustic perception model. Moving Picture Experts Group (MPEG) series and Dolby codecs correspond to the audio codecs. In general, it is efficient to apply the CELP technology to a speech signal and the psychoacoustic perception model to an audio signal such as music. Recently, there have been attempts to mix these technologies.

Conditions of codecs used in networks and terminals are different. In an Internet Protocol (IP) network having a wide bandwidth, a codec having a high transmission rate with high sound quality can be used. However, in a wireless communication environment such as mobile communication, a codec having a low transmission rate with low sound quality is used. Even in the same network, a bandwidth and an available transmission rate significantly fluctuate according to traffic.

While a softphone of a PC environment can provide a complexity sufficient to use a high quality codec, a terminal using a separate Digital Signal Processor (DSP) for processing the much complexity is more expensive. In order to use the same codec in various application fields, bitstream scalability using an embedded type bitstream structure needs to be provided. G.729.1, which was recently standardized by International Telecommunication Union (ITU), has the embedded type bitstream structure.

Embedded type codecs provide bandwidth scalability to a narrowband speech (300 to 3400 Hz) and a wideband speech (50 to 7000 Hz) in general, and if bit-rate scalability is minutely achieved, the bandwidth scalability must be achieved using a small number of bits. For example, in G.729.1, a low-band signal must be generated at 12 kbps and a high-band signal must be generated at 14 kbps, improving sound quality of the low-band signal and the high-band signal in a unit of 2 kbps. To do this, various technologies, such as bandwidth extension, spectral band replication, etc., are introduced in a bit rate in which bandwidth scalability is achieved, and compression is performed using a frequency coefficient quantization method in a higher bit rate. However, in this case, more complexity is necessary.

### SUMMARY OF THE INVENTION

The present invention provides a speech coding apparatus and method for maintaining algorithm consistency and reducing a complexity by extending a bandwidth with a small number of bits in a speech codec.

The present invention provides a computer readable recording medium storing a computer readable program for executing the speech coding method.

According to an aspect of the present invention, there is provided a speech coding apparatus comprising: a band divider dividing an input signal into a high-band signal and a low-band signal; a narrowband encoder encoding the low-band signal using a Code Excited Linear Prediction (CELP)-based narrowband speech codec; a frequency characteristic collector converting the high-band signal to a signal in a frequency domain and obtaining Modified Discrete Cosine Transform (MDCT) coefficients; a subband determiner determining subbands in a final stage based on the MDCT coefficients and determining subbands for initial or current quantization based on the subbands in a final stage; a gain quantizer performing gain quantization of the subbands; a bit assignment unit assigning bits to the subbands according to the magnitude of the gain quantization; and a shape quantizer performing shape quantization of the subbands in an algebraic method.

According to another aspect of the present invention, there is provided a speech coding method comprising: dividing an input signal into a high-band signal and a low-band signal; encoding the low-band signal using a Code Excited Linear Prediction (CELP)-based narrowband speech codec; converting the high-band signal to a signal in a frequency domain and obtaining Modified Discrete Cosine Transform (MDCT) coefficients; determining subbands in a final stage based on the MDCT coefficients and determining subbands for initial or current quantization based on the subbands in a final stage; performing gain quantization of the subbands; assigning bits to the subbands according to the magnitude of the gain quantization; and performing shape quantization of the subbands in an algebraic method.

Accordingly, algorithm consistency can be maintained and a complexity can be reduced by extending a bandwidth with a small number of bits in a speech codec.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a speech coding apparatus according to an embodiment of the present invention;

FIG. 2 is a flowchart of a speech coding method according to an embodiment of the present invention; and

FIG. 3 is a flowchart of a shape quantization process according to an embodiment of the present invention.

### DETAILED DESCRIPTION OF THE INVENTION

Hereinafter, the present invention will now be described in detail by explaining preferred embodiments of the invention with reference to the attached drawings.

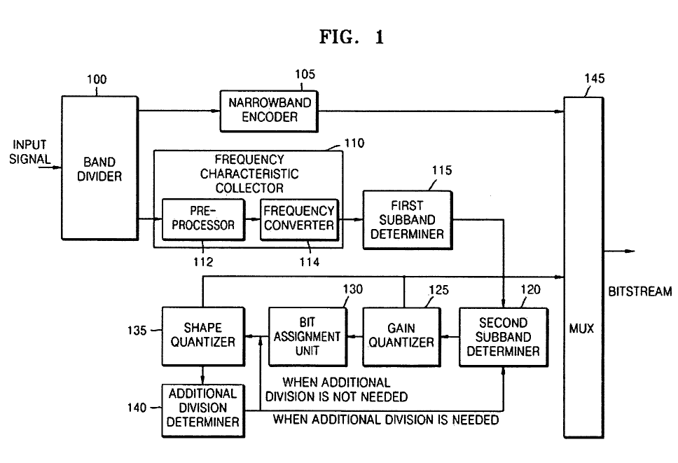

FIG. 1 is a block diagram of a speech coding apparatus according to an embodiment of the present invention.

Referring to FIG. 1, the speech coding apparatus includes a band divider 100, a narrowband encoder 105, a frequency characteristic collector 110, first and second subband determiners 115 and 120, a gain quantizer 125, a bit assignment unit 130, a shape quantizer 135, an additional division determiner 140, and a multiplexer (MUX) 145.

The band divider 100 divides an input signal into a high-band signal and a low-band signal using a filter bank such as a Quadrature Mirror Filter (QMF). If necessary, the band divider 100 decimates the high-band signal and/or the low-band signal. For example, the band divider 100 achieves frequency symmetry by decimating the low-band signal by 2 and decimating the high-band signal by 2.

The narrowband encoder 105 encodes the low-band signal using a conventional narrowband speech codec based on the Code Excited Linear Prediction (CELP) technology.

The frequency characteristic collector 110 obtains Modified Discrete Cosine Transform (MDCT) coefficients by pre-processing the high-band signal and performing frequency conversion. In detail, the frequency characteristic collector 110 includes a pre-processor 112 and a frequency converter 114. The pre-processor 112 performs a pre-processing process in which components of more than 3000 Hz is removed using a low pass filter (LPF), and the frequency converter 114 converts the pre-processed signal to a signal in a frequency domain using MDCT.

The first subband determiner 115 determines the number of subbands in a final stage based on the MDCT coefficients. In detail, the first subband determiner 115 determines the number of subbands in a final stage using a critical band or using a radical number of 2, and assigns the MDCT coefficients. For example, if the number of MDCT coefficients is 240, the first subband determiner 115 determines that the number of subbands in a final stage is 16. That is, 15 MDCT coefficients compose a single subband.

The second subband determiner 120 determines subbands for initial quantization based on the subbands determined by the first subband determiner 115. That is, the second subband determiner 120 determines subbands for initial quantization by binding several subbands in a final stage. For example, it is determined that the number of subbands for initial quantization is 8, a single subband for initial quantization is obtained by binding 2 subbands in a final stage. The second subband determiner 120 also divides each subband into two in order to obtain subbands for current quantization after the initial stage.

The gain quantizer 125 performs gain quantization of the subbands determined by the second subband determiner 120. The gain quantizer 125 obtains the logarithm of a value obtained by dividing subband energy by the number of subband dimensions in the initial stage, and thereafter, performs quantization of a subband having a larger gain among divided subbands when the gain quantization is repeatedly performed. That is, the gain quantizer 125 performs the gain quantization of each subband for gain quantization and encodes the gain quantization result using a Huffman code.

The bit assignment unit 130 assigns bits to the gain subbands according to the gain magnitude. The sum of all subband bits must be close to the maximum number of bits which can be transmitted. The bit assignment unit 130 assigns bits according to the gain and the subband dimension considering the maximum bit rate in the initial stage, and thereafter, divides previously assigned subband bits according to a gain ratio of divided subbands.

The shape quantizer 135 performs shape quantization in an algebraic method. In detail, in the initial stage or if the number of subbands in a final stage is greater than the number of subbands for initial or current quantization, the shape quantizer 135 performs the shape quantization of each of all subbands once, and if the number of subbands in a final stage is equal to the number of subbands for initial or current quantization, the shape quantizer 135 performs the shape quantization using all bits assigned to a subband having the maximum number of bits.

If the above-described process is initially performed, a bitstream corresponding to a first bit rate for generating the high-band signal of the codec is generated. In order to generate a bitstream corresponding to a subsequent bit rate after the initial stage, the above-described quantization process is repeated.

When the above-described quantization process is repeated, the additional division determiner 140 determines whether additional division of the subbands for gain quantization is needed. If the additional division determiner 140 determines that the additional division is needed, the process is repeatedly performed from the determination of subbands for gain quantization, and if the additional division determiner 140 determines that the additional division is not needed, the process is repeatedly performed from the shape quantization.

In detail, if the number of subbands in a final stage is greater than the number of subbands in an initial or current stage, the additional division determiner 140 determines that the additional division is needed. When the additional division is performed, the gain quantizer 125 obtains a subband having a larger gain among divided subbands, and the bit assignment unit 130 divides sub-band bits assigned in a previous loop according to a gain ratio. For example, if 36 bits are assigned to a subband for gain quantization in a previous loop, and if a gain ration of two subbands in a current loop is 2:1, the bit assignment unit 130 assigns 24 bits and 12 bits to the two subbands. The shape quantizer 135 performs the shape quantization of each subband in an algebraic method. If the additional division determiner 140 determines that the additional division is not needed, the shape quantizer 135 performs the shape quantization from a subband having the maximum number of bits until all bits are consumed. From a second loop, if the number of bits corresponding to a transmission bit rate is satisfied, the bits are transmitted.

The MUX 145 transmits a bitstream obtained by multiplexing the low-band signal and the high-band signal.

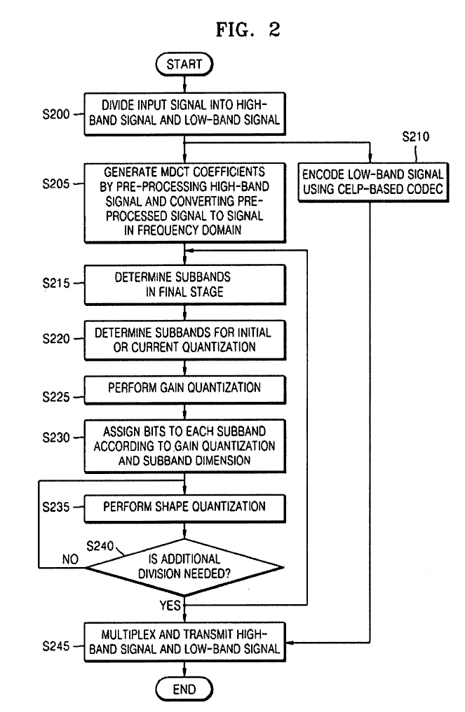

FIG. 2 is a flowchart of a speech coding method according to an embodiment of the present invention.

Referring to FIG. 2, a speech coding apparatus according to an embodiment of the present invention divides an input signal into a high-band signal and a low-band signal in operation S200. The low-band signal is encoded using a CELP-based narrowband speech codec in operation S210.

The speech coding apparatus obtains MDCT coefficients by pre-processing the high-band signal and converting the pre-processed signal to a signal in the frequency domain in operation S205. The speech coding apparatus determines subbands in a final stage and subbands for initial or current quantization based on the MDCT coefficients in operations S215 and S220 and performs gain quantization of the subbands in operation S225. The speech coding apparatus assigns bits to each subband according to the gain quantization and a subband dimension in operation S230 and performs shape quantization in operation S235. If the process is repeatedly performed after an initial stage, the speech coding apparatus determines in operation S240 whether additional division is needed. If it is determined in operation S240 that the additional division is needed, the speech coding apparatus proceeds to operation 215 to determine subbands for current quantization, and if it is determined in operation S240 that the additional division is not needed, the speech coding apparatus proceeds to operation 235 to perform the shape quantization. The speech coding apparatus multiplexes the encoded low-band and high-band signals and transmits the multiplexed signal in operation S245.

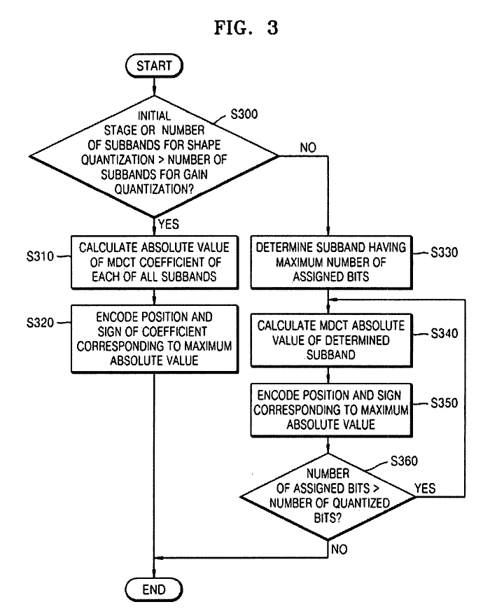

FIG. 3 is a flowchart of a shape quantization process according to an embodiment of the present invention.

Referring to FIG. 3, in an initial stage, the shape quantization is performed for each of all bands once in operation S300. Besides, if the number of subbands in a final stage is greater than the number of subbands in an initial or current stage, the shape quantization is performed for each of all subbands once in operation S300. An MDCT coefficient absolute value is obtained for each of all subbands in operation S310, and a position and the sign of a coefficient corresponding to the absolute value are encoded by an algebraic method in operation S320. If the number of subbands in a final stage is equal to the number of subbands in an initial or current stage, a subband having a maximum number of assigned bits is determined in operation S330, and an MDCT absolute value of the determined subband is calculated in operation S340. A position and sign corresponding to the absolute value are encoded in operation S350, and it is determined in operation S360 whether the number of assigned bits is greater than the number of quantized bits. If it is determined in operation S360 that the number of assigned bits is greater than the number of quantized bits, the process is repeated from the calculating of the MDCT absolute value.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

As described above, according to the present invention, since there does not have to try another method in order to extend a narrowband to a wideband or an audio band in a codec requiring fine bit-rate scalability, algorithm consistency can be maintained and a complexity can be reduced.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A speech coding apparatus comprising:
a band divider dividing an input signal into a high-band signal and a low-band signal;
a narrowband encoder encoding the low-band signal using a Code Excited Linear Prediction (CELP)-based narrowband speech codec;
a frequency characteristic collector converting the high-band signal to a signal in a frequency domain and obtaining Modified Discrete Cosine Transform (MDCT) coefficients;
a subband determiner determining subbands in a final stage based on the MDCT coefficients and determining subbands for initial or current quantization based on the subbands in a final stage;
a gain quantizer performing gain quantization of the subbands determined by subband determiner;
a bit assignment unit assigning bits to the subbands determined by subband determiner according to the magnitude of the gain quantization; and
a shape quantizer performing shape quantization of the subbands determined by subband determiner in an algebraic method.

2. an additional division determiner determining based on the number of subbands for initial or current quantization and the number of subbands in a final stage whether additional division is performed.

3. The speech coding apparatus of claim 1, wherein the subband determiner comprises:
a first subband determiner determining the number of subbands in a final stage using a critical band or using a radical number of 2 and assigning the MDCT coefficients; and
a second subband determiner determining subbands for initial quantization based on the subbands in a final stage determined by the first subband determiner.

4. The speech coding apparatus of claim 3, wherein the second subband determiner divides each subband obtained in a previous stage into two in order to obtain subbands for current quantization after the initial stage.

5. The speech coding apparatus of claim 1, wherein the gain quantizer obtains the logarithm of a value obtained by dividing subband energy by the number of subband dimensions in the initial stage, and thereafter, performs quantization of a subband having a larger gain among divided subbands when the gain quantization is repeatedly performed.

6. The speech coding apparatus of claim 1, wherein the bit assignment unit assigns bits according to the gain and the subband dimension considering the maximum bit rate in the initial stage, and thereafter, divides previously assigned subband bits according to a gain ratio of divided subbands.

7. The speech coding apparatus of claim 1, wherein in the initial stage or if the number of subbands in a final stage is greater than the number of subbands for current quantization, the shape quantizer performs the shape quantization of each of all subbands once, and if the number of subbands in a final stage is equal to the number of subbands for current quantization, the shape quantizer performs the shape quantization using all bits assigned to a subband having the maximum number of bits.

8. A speech coding method comprising:
dividing an input signal into a high-band signal and a low-band signal;
encoding the low-band signal using a Code Excited Linear Prediction (CELP)-based narrowband speech codec;
converting the high-band signal to a signal in a frequency domain and obtaining Modified Discrete Cosine Transform (MDCT) coefficients;
determining subbands in a final stage based on the MDCT coefficients and determining subbands for initial or current quantization based on the subbands in a final stage;
performing gain quantization of the subbands;
assigning bits to the subbands according to the magnitude of the gain quantization; and
performing shape quantization of the subbands in an algebraic method.

9. The speech coding method of claim 8, further comprising determining based on the number of subbands in a final stage and the number of subbands in an initial or current stage whether additional division is performed.

10. The speech coding method of claim 9, wherein the determining of whether additional division is performed comprises if the number of subbands in an initial or current stage is less than the number of subbands in a final stage, determining that the additional division is performed and repeatedly performing from the determining of the subbands for quantization when the additional division is performed, and if the additional division is not needed, repeatedly performing from the performing of the shape quantization.

11. The speech coding method of claim 8, wherein the determining of the subbands comprises:
determining the number of subbands in a final stage using a critical band or using a radical number of 2 and assigning the MDCT coefficients; and
determining subbands for initial quantization based on the subbands in a final stage.

12. The speech coding method of claim 11, wherein the determining of the subbands for initial quantization comprises dividing each subband for quantization obtained in a previous stage into two in order to obtain subbands for quantization after the initial stage.

13. The speech coding method of claim 8, wherein the performing of the gain quantization comprises obtaining the logarithm of a value obtained by dividing subband energy by the number of subband dimensions in the initial stage, and thereafter, performing quantization of a subband having a larger gain among divided subbands when the gain quantization is repeatedly performed.

14. The speech coding method of claim 8, wherein the assigning of the bits comprises assigning bits according to the gain and the subband dimension considering the maximum bit rate in the initial stage, and thereafter, dividing previously assigned subband bits according to a gain ratio of divided subbands.

15. The speech coding method of claim 8, wherein the performing of the shape quantization comprises in the initial stage or if the number of subbands in a final stage is greater than the number of subbands for initial or current quantization, performing the shape quantization of each of all subbands once, and if the number of subbands in a final stage is equal to the number of subbands for initial or current quantization, performing the shape quantization using all bits assigned to a subband having the maximum number of bits.
